(19) United States
(12) Patent Application Publication
(10) Pub. No.: US 2005/0184437 A1
(43) Pub. Date: Aug. 25, 2005

(54) Mounting devices utilizing elastomers of differing characteristics and post-vulcanization bonding

(75) Inventors: William O. Hogue, Brookville, OH (US); Thomas E. Rau, Dayton, OH (US); Frederick C. Miller, Beavercreek, OH (US)

Correspondence Address: DELPHI TECHNOLOGIES, INC.;M/C 480-410-202, 5825 DELPHI DRIVE, TROY, MI, 48098-2815, US

(73) Assignee: DELPHI TECHNOLOGIES INC.

(21) Appl. No.: 10/784,362

(22) Filed: Feb. 23, 2004

(51) Int. Cl. F16F 7/00

(52) U.S. Cl. 267/141

(57) ABSTRACT

The invention includes a mount having an input side attachment member and a plurality of isolation pads positioned within the input side attachment member. At least two of the pads have different performance characteristics. The invention further includes an output side attachment member positioned within the input side attachment member and one or more of the pads are post-vulcanization bonded to at least one of the input side attachment member and the output side attachment member.

### TECHNICAL FIELD OF THE INVENTION

The present invention relates generally to mounting systems. More particularly, the invention relates to a mount system including individual mounting devices, one or more of which utilizes elastomeric pads, which themselves have different performance characteristics from each other, and are affixed to the bracket or structural members of the mount or to each other with post-vulcanization bonding.

### BACKGROUND OF THE INVENTION

Cushioning or mounting members are employed to support or to provide a cushioned connection between suspension members. Such isolation members are common in automotive applications, as well as other applications ranging from disk drives to seismic isolators. In an automotive application, for example, a typical engine mount or transmission mount employs a resilient body of polyisoprene rubber, or other suitable elastomer material, sandwiched, sometimes under pressure, between cooperating bracket members. One of the bracket members is connected to the engine or to the transmission, and another bracket member is attached to a vehicle body member. In addition to being sandwiched and sometimes compressed between the bracket members, the rubber or other elastomer is adhesively bonded to the brackets.

In other applications, similar structures exist. For example, disk drive mounts isolate the drive head from vibration. In such mounts, a resilient body of polyisoprene rubbers doped or not doped with different elastomers is sandwiched between cooperating bracket members, with one bracket member attached to the drive head and the other bracket member attached to the drive chassis.

The bonding requirement in such an application can vary from structural to nonstructural. In structural bonding, where the bond is expected to sustain a substantial load, the bond is considered successful if the entire bracket or substrate is covered with torn rubber after failure of the test specimen. In nonstructural bonding, the rubber-bracket interface is not subjected to large tensile or shear loads. It is only necessary to keep the rubber in intimate contact with the bracket. The bracket is usually, but not necessarily always, steel or aluminum. The formulation or selection of the rubber elastomer affects the performance of the mount, and can be tuned to meet particular design parameters. For instance, if the mount is to control motion under large oscillatory vibrations, a relatively hard rubber is used. Conversely, if the mount is to reduce transmission of smaller, higher frequency vibrations, a relatively soft rubber may be desirable.

The techniques employed for such rubber bonding are divided depending on whether the bond is made while the rubber cures, in-mold bonding, or after cure, post-vulcanization bonding. In-mold bonding is the accepted method for the manufacture of many natural or synthetic polyisoprene rubber bonded articles such as mounting devices. In these articles, a rigid insert, commonly a steel tube, is substantially surrounded by a body of rubber. An adhesive is applied on the rigid insert from a solvent or water carrier and then dried. The insert is then placed like a core member in the rubber mold prior to injection of the uncured rubber. Adhesive cure takes place during the rubber curing process. Examples of suitable adhesives for in-mold or pre-vulcanization are the reactive elastomeric adhesive products sold under the trade names of Chemlok™. and Thixon™, respectively, by Lord Corporation and Rohm and Haas in the United States. A number of techniques are used for post-vulcanization bonding. Conventional post-vulcanization bonding utilizes the same type of reactive elastomeric adhesive used for in-mold bonding. In this case, the cured rubber mass is held in contact with the surfaces coated with the reactive elastomeric adhesive and heated. Substantial pressure is required, often requiring the rubber to be compressed by about 20% of its original height. This method is particularly attractive for products such as bonded bushings where a cylindrical mass of rubber is compressed within an annular outer shell. The pressure requirement is easily met by the rubber being captured within the outer shell.

The use of epoxy resin in the manufacture of vehicular powertrain mounts was taught as an alternative to conventional post-vulcanization bonding utilizing reactive elastomeric adhesives in U.S. Pat. Nos. 4,987,679 and 5,031,873, issued Jul. 16, 1991 and Jan. 29, 1991 respectively and assigned to the assignee of this invention, each of which is hereby incorporated by reference. This process, herein referred to as PV Bonding, utilizes a structural adhesive, for example a two-component epoxy adhesive, to bond cured rubber to rigid inserts or to attaching and mounting members. The primary advantage of the epoxy adhesive over conventional post-vulcanization bonding using reactive elastomeric adhesives is that high pressure is not required to achieve good bonds. Also, a fair amount of mismatch between the rubber and the rigid insert can be tolerated because the mixed but uncured epoxy is mobile and fills gaps and still bonds well. This technology has made it attractive to convert designs that would otherwise be in-mold bonded. In this application the bracket or structural member of the mount may be coated via cathodic electrodeposition, commonly referred to as E-coat, or otherwise suitably prepared to form a primed surface on the bracket or structural members for the structural adhesive to bond with.

As an alternative to PV Bonding with the structural adhesive above, producing post-vulcanization bonding by directly applying heat and pressure on a chlorinated rubber pad against an E-Coated surface is taught in U.S. Pat. No. 6,428,645 issued Aug. 6, 2002 assigned to the assignee of this invention, and is hereby incorporated by reference. This post-vulcanization method is herein referred to as Direct E-Coat PV Bonding.

Those of ordinary skill in the automotive art recognize that modern powertrain and strut mounts serve multiple functions. Powertrain mounts support the powertrain, isolate the chassis and hence the vehicle body and passenger compartment from powertrain vibrations due to engine and transmission operation, powertrain vibration resulting from suspension road inputs, and restrain the powertrain in the event of rapid deceleration, acceleration or dynamic or static torque events. Strut mounts isolate the vehicle body and passenger compartment from road vibrations and serve as the top support for the suspension. As the support for the suspension, strut mounts are configured to maintain the position of the strut rod during cornering maneuvers as well as under jounce loading.

Design of mounts has historically been compromised by the multiple design goals. A low durometer (i.e. soft) rubber or other elastomer formulation may be optimal for isolating vibrations, but results in a less optimal support under loading. Conversely, a high durometer (i.e. hard) rubber or other elastomer formulation may result in optimal support under loading but less than optimal isolation from vibrations. Similarly, rubber or other elastomer compounds formulated for a particular design goal, e.g. temperature resistance, resistance to sag or permanent set, or specific dynamic characteristics, may have performance characteristics that preclude the achievement of other design goals. As a result, mounts are typically designed and manufactured of a single rubber or elastomer compound with the shape of the rubber or elastomer being different in different areas of the mount to attempt to reach a reasonable compromise among the various competing design goals. The development cycle for such mounts requires iterative, time-consuming and expensive mold changes to reach the correct overall rubber or elastomer shape.

Dual or multiple durometer mounts have been proposed, but manufacturing methods have hampered prior art multiple durometer mounts. Construction of a multiple durometer mount required simultaneous injection of at least two rubber compounds. In a simple mount, such as the mount used by Inlan for the Opel J, such manufacturing methods are possible, but difficult. However, the manufacture of mounts for more advanced applications and designs renders simultaneous injection of multiple rubber compounds impractical. The complexity of the mold design undesirably increases the cost of such a manufacturing process. A major technical difficulty with any in-mold multiple isolation pad scheme is the need to seal rubber pad areas on intersecting planes—a task that increases lead time and makes the molding process less robust with respect to bite rings and other mold features designed to seal off on inserts and less robust with respect to insert features that mate with these mold details.

One proposed solution to this problem is the use of a multiple step process. Thus, multiple steps obviate the need to simultaneously inject a mold. Such a solution involves injection and curing of a sub-assembly that utilizes a single rubber or elastomer formulation of a particular performance characteristic. The sub-assembly is then removed from the mold, cooled, and additional adhesive is applied at the bonding location(s) for the second rubber or elastomer of a different performance characteristic. The sub-assembly is run through an injection and curing process a second time utilizing a second mold and press set-up. This process is repeated as many times as necessary, consuming significant time and effort.

In U.S. Pat. No. 6,030,016 issued Feb. 29, 2000, Rice discloses a rebound cushion for a body mount. The Rice cushion is a rebound cushion that includes an injection-molded cushion with two durometer characteristics. The cushion is maintained in place with a cutout area of the metallic mount, and by a clamp disk.

This invention advances the state of the art.

### SUMMARY OF THE INVENTION

One aspect of the invention provides a mount including an input side attachment member and a plurality of isolation pads positioned within the input side attachment member. At least two of the pads have different performance characteristics. The invention further includes an output side attachment member wherein at least a portion of the output side attachment is positioned within the input side attachment member, wherein one or more of the pads are post-vulcanization bonded to at least one of the input side attachment member and the output side attachment member.

Another aspect of the invention provides a mount including an input side attachment member and a plurality of isolation pads positioned within the input side attachment member. At least two of the pads have different performance characteristics. The invention further includes an output side attachment member positioned within the input side attachment member, wherein one or more of the pads are post-vulcanization bonded to at least one of the input side attachment member and the output side attachment member.

Another aspect of the invention provides a strut mount including an output side attachment member attached to the strut mount with a strut body; and a plurality of isolation pads positioned between the output side attachment member and the strut body wherein at least two of the pads comprise different performance characteristics, and wherein at least two of the pads are post-vulcanization bonded to the strut body.

Yet another aspect of the invention provides a method of manufacturing a mount. The method includes the steps of positioning a plurality of isolation pads adjacent a surface of the mount, wherein at least two of the pads have different performance characteristics; and post-vulcanization bonding a portion of at least one of the pads to the surface of the mount.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is a perspective view of one embodiment of a mount in accordance with one aspect of the invention;

FIG. 2 is a perspective view of one embodiment of a mount in accordance with another aspect of the invention;

FIG. 3A is a perspective view of one embodiment of a mount in accordance with another aspect of the invention;

FIG. 3B is a perspective view of one embodiment of a mount in accordance with another aspect of the invention;

FIG. 3C is a perspective view of one embodiment of a mount in accordance with another aspect of the invention;

FIG. 4 is a perspective view of one embodiment of a mount in accordance with another aspect of the invention; and

FIG. 5 is a flowchart depicting a method for constructing one embodiment of a mount in accordance with the instant invention.

### DESCRIPTION OF THE PRESENTLY PREFERRED EMBODIMENTS

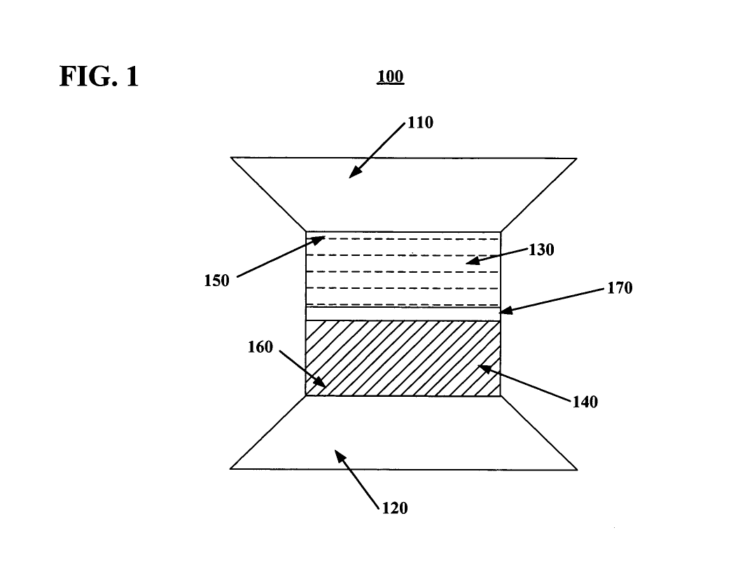

FIG. 1 is a perspective view of one embodiment of a mount 100 in accordance with one aspect of the invention. Mount 100 includes an active or input-side attachment member 110 and a passive or output-side attachment member 120.

Isolation Pads of rubber or other elastomer, 130, 140, having different performance characteristics from each other are each in-mold bonded, PV Bonded, or Direct E-Coat PV Bonded 150, 160 to their adjacent attachment members. In addition, the isolation pads are PV Bonded 170 to each other, in one embodiment. In one embodiment, the isolation pads are each PV Bonded or Direct E-Coat PV Bonded to a relatively inflexible intermediate member of metal or other suitable material situated between the isolation pads (not shown).

In one embodiment, isolation pad 130 is of a rubber or other elastomer compound formulated to maintain performance characteristics in a high temperature environment as would be encountered, for example, in close proximity to an automotive engine block; however, isolation pad 140 is of a rubber or other elastomer compound that is formulated to resist sag or change in height of the pad, and thus the in-vehicle position of the engine in this example, over time. In other embodiments, isolation pads 130, 140 are formulated for other performance characteristics.

In one embodiment, isolation pads 130, 140 are themselves comprised of two or more sub-pads (not shown) which may or may not be of different performance characteristics and which are PV Bonded to each other or are PV Bonded or Direct E-Coat PV Bonded to an intermediate member situated between sub-pads.

The material used to construct attachment members 110, 120 depends on the application. For example, in automotive applications, attachment members 110, 120 are optimally manufactured from a very hard and durable material capable of supporting in excess of 1500 pounds and capable of withstanding strong vibratory forces, such as steel or other appropriate metal. In another application, such as a disk drive mount, the containment member is subject to different forces, and may be manufactured from other materials, such as plastic or fiberglass.

The inventors found that using PV bonding or Direct E-Coat PV Bonding with isolation pads of different performance characteristics resulted in a mount that could be tuned to optimize performance across a variety of performance demands while avoiding many of the difficulties encountered with prior art attempts to solve the same problem. Thus, a common metal structure with multiple options for performance is possible with minimized tooling changes. The use of mounting devices with a common structure and attachment points across multiple platforms is enabled with the use of multiple performance characteristic isolation pads PV bonded or Direct E-Coat PV Bonded to the underlying structures.

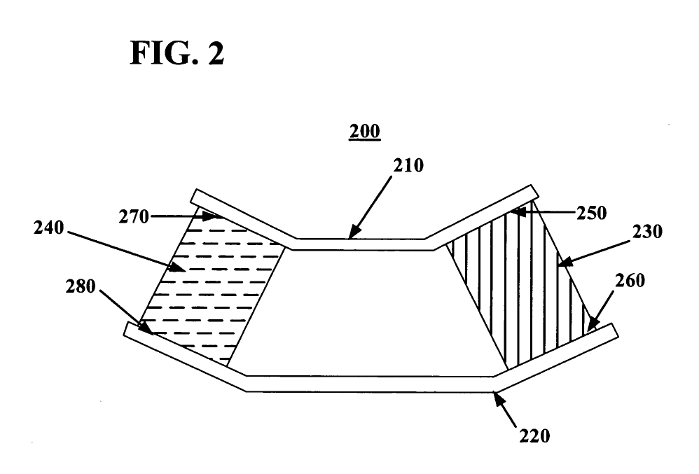

FIG. 2 illustrates an embodiment of a mount 200 in accordance with one aspect of the invention. Mount 200 includes an active or input-side attachment member 210 and a passive or output-side attachment member 220. Isolation pads 230, 240 having different performance characteristics from each other are each PV Bonded or Direct E-Coat PV Bonded 250, 260, 270, 280 to both attachment members 210, 220. Using an automotive transmission mount application as an example, isolation pad 230 may be of a rubber or other elastomer having a low dynamic rate for a given static rate such that, when compressed during drive or positive torque application, would transmit less vibration from the active or input-side attachment member 210 to the passive or output-side attachment member 220. In this example, isolation pad 240 may be of a rubber or other elastomer requiring a high force to deflect the pad in compression such that the rotation of the powertrain is limited with reverse or negative torque application.

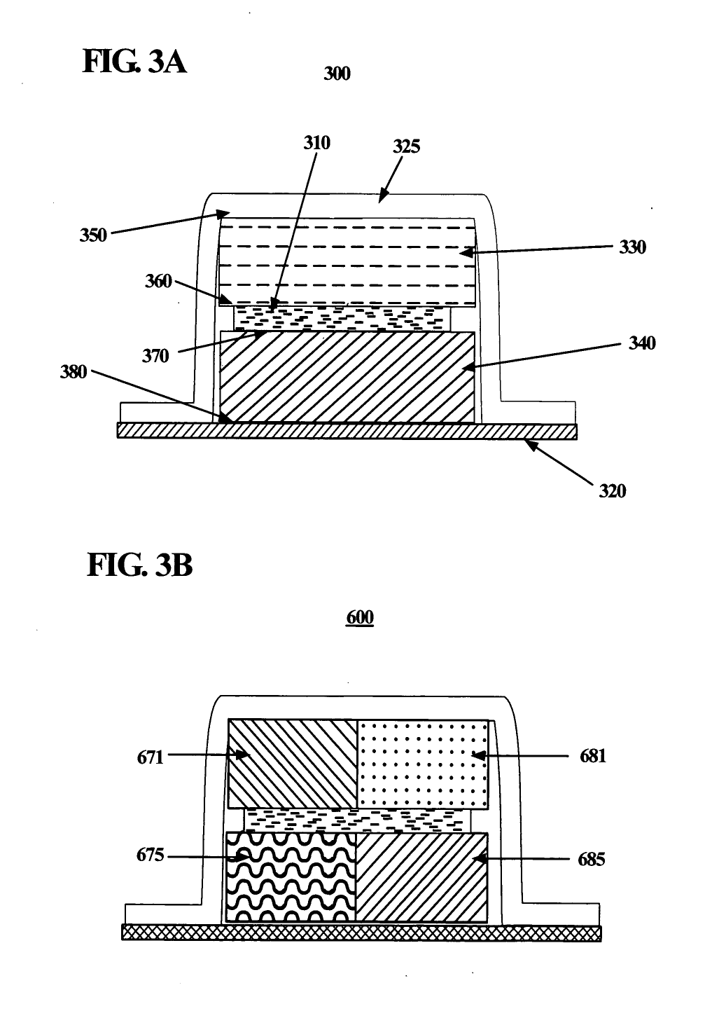

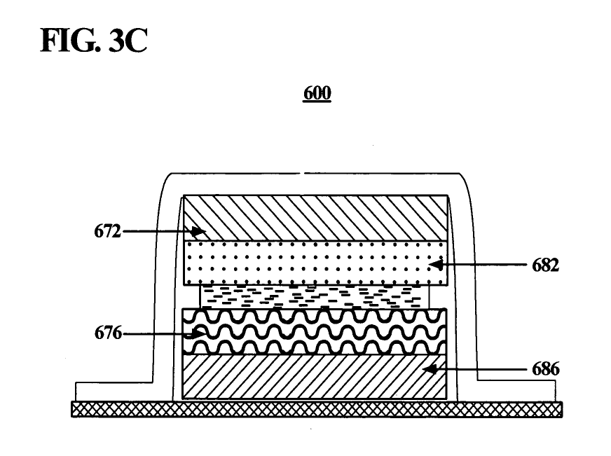

FIG. 3A depicts a perspective view of one embodiment of a mount 300 in accordance with one aspect of the invention. Mount 300 includes an active or input-side attachment member 310, a passive or output-side attachment member 320 and a plurality of isolation pads 330, 340. In addition, in one embodiment, a containment member 325 is employed such that it is attached, either during the mount manufacturing process or by way of installation to attachment member 320. In another embodiment, a containment member 325 is employed such that it is not attached, either during the mount manufacturing process or by way of installation to attachment member 320. At least one isolation pad is PV Bonded or Direct E-Coat PV Bonded 350, 360, 370, 380 to at least one of the attachment members or containment member 310, 320, 325. The isolation pads 330, 340 may or may not be under a compressive preload due to disposition of the containment member 325 with reference to attachment member 320. In one embodiment, isolation pad 330 may be of a relatively soft rubber or other elastomer such that isolation is maximized when pad 330 is compressed or extended, while isolation pad 340 may be a rubber or other elastomer formulated such that a high force is required to deflect the pad to avoid metal-to-metal contact within the mount or amongst the attaching structures during large excursion inputs.

In FIG. 3B the isolation pads attached to mount 600 are themselves comprised of more than one sub-pad 671, 675,681, 685, each of which are PV Bonded to each other or are PV Bonded or Direct E-Coat PV Bonded to an intermediate member of metal or other suitable material. The embodiment illustrated in FIG. 3B provides for optimization of uneven loads carried within the mount. For example, in a powertrain application, higher forces may be present at the toe or heel of the mount, and the isolation pads at these locations are selected for their performance.

In FIG. 3C, the isolation pads attached to mount 600 are themselves comprised of more than one sub-pad 672, 676,682, 686, each of which are PV Bonded to each other or are PV Bonded or Direct E-Coat PV Bonded to an intermediate member of metal or other suitable material. Other configurations of sub-pad configurations are anticipated, including embodiments with more than two sub-pads, as well as configurations wherein the sub-pads are configured disposed such that each isolation pad comprises a substantially triangular configuration.

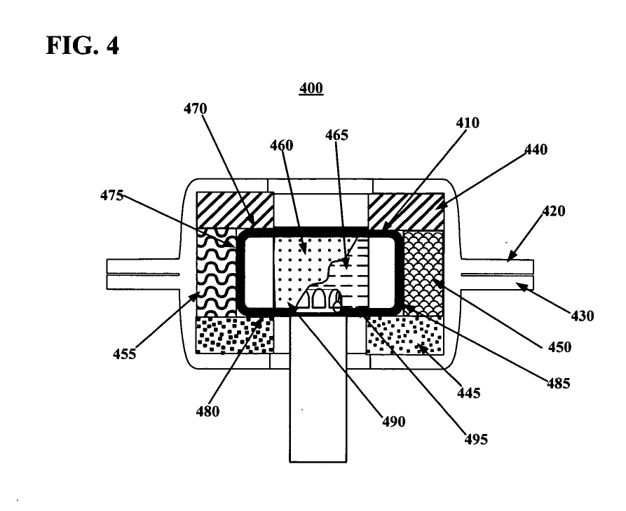

FIG. 4 illustrates an embodiment of a strut mount 400 in accordance with one aspect of the invention. Mount 400 includes an active-side or suspension-side mounting member 410, such as, for example, a strut body and a passive-side or body-side attachment member, which in this embodiment is comprised of an upper and lower attachment member 420 and 430 respectively. A plurality of isolation pads 440, 445, 450, 455, 460, 465 is positioned between the mounting member and the attachment members, and at least two of the pads have different performance characteristics. At least two of the isolation pads 440, 445, 450, 455, 460, 465 are PV Bonded or Direct E-Coat PV Bonded 470, 475, 480, 485, 490, 495 to the suspension-side mounting member 410.

In one embodiment pad 440 is a jounce pad, 445 is a rebound pad, 450 is an aft pad, 455 is a fore pad, 460 is a lateral inboard pad, and 465 is a lateral outboard pad. In one embodiment, at least one of the pads 440, 445, 450, 455, 460, 465 has different performance characteristics from the others to enable optimization of overall mount performance. In another embodiment, at least two of the pads are PV Bonded together, in addition to being bonded to the mounting member 410. In yet another embodiment, at least two of the pads are PV Bonded together or PV Bonded or Direct E-Coat PV Bonded to an intermediate member. (not shown).

For example, in an automotive application, a common suspension-side mounting member 410 may be provided for multiple lines of vehicles. In a performance vehicle line, the isolation pads may be harder than the pads included in a luxury performance vehicle line. Thus, in order to tune the performance of the mount to attain desired characteristics, a single mounting member may support isolation pads of varied performance characteristics optimized for individual vehicle lines. Further optimization is allowed by use of different pad characteristics for fore and aft and lateral inboard and lateral outboard. Another advantage is reduction of development time and cost resulting from the ability to change the jounce, rebound, fore/aft, and lateral stiffness during component and vehicle development testing without waiting on mold changes between trials. This is enabled by simply changing performance characteristics of the pads rather than their shape to achieve mount performance changes and the ability to quickly produce and test multiple combinations due to not being constrained by having a single molded shape for the entire mount and/or a single rubber or other elastomer formulation. Those of ordinary skill in the art will readily recognize that struts are used in a variety of applications, and in no way should this invention be construed as limited to automotive applications.

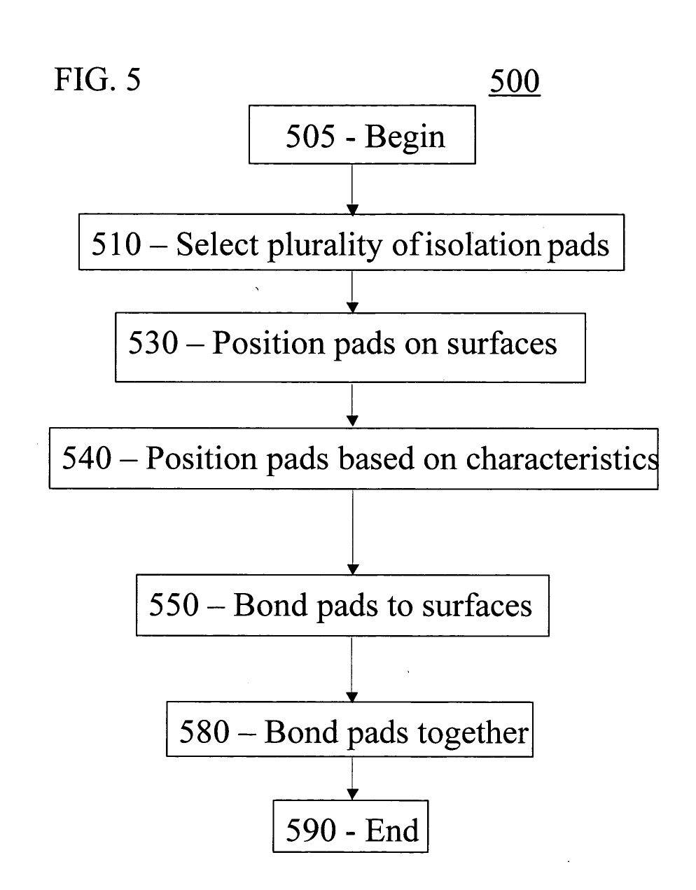

FIG. 5 is a flowchart illustrating one embodiment of a method of manufacturing a mount in accordance with the invention. As illustrated in FIG. 5, method 500 begins at block 505. At block 510, a plurality of isolation pads is selected in response to performance characteristics. At least two of the isolation pads comprise different performance characteristics. At block 530, a plurality of isolation pads are positioned adjacent a surface of the mount. At least two of the isolation pads comprise different performance characteristics. For example, one pad may comprise a relatively high durometer or stiffness characteristic, while another pad comprises a relatively low durometer or stiffness characteristic.

At block 540, the pads are positioned in response to their performance characteristics. Thus, a pad with a relatively high durometer or stiffness characteristic is placed in a position where the pad may support a relatively high weight, in one embodiment. In another embodiment, a pad with a relatively low durometer or stiffness is positioned to provide a greater degree of vibration isolation.

At block 550, the plurality of isolation pads is PV bonded or Direct E-Coat PV Bonded to the surface of the mount. At block 580, at least two of the isolation pads are PV bonded to each other or PV Bonded or Direct E-Coat PV Bonded to an intermediate member. In one embodiment, blocks 550 and 580 occur substantially simultaneously.

At block 590, method 500 ends.

Post Vulcanization bonding, PV bonding, and Direct E-coat bonding as a group of tools make it economically feasible to create mount assemblies satisfying the multiple requirements of, for example, automotive powertrain and strut mounts by utilizing two or more elastomers having differing characteristics. Performance characteristics include, for example, durometer characteristics, temperature characteristics, as well as any other characteristic that may be configurable to attain a design goal. Furthermore, the isolation pads may comprise a rubber material, as well as any other appropriate material to attain a design goal.

While the embodiments of the invention disclosed herein are presently considered to be preferred, various changes and modifications can be made without departing from the spirit and scope of the invention. For example, the mount assembly is not limited to any particular design, configuration, or arrangement. Specifically, the isolation pads, and characteristics such as, for example, size, shape, geometry, location, orientation, and number, may vary without limiting the utility of the invention. Indeed, any characteristic of the rubber compound may vary, and the invention applies to alterations in addition to durometer or stiffness characteristics. Thus, not only can the durometer characteristic vary among isolation pads used in a single mount, but the sag resistance, static rate ratio and heat resistance, among other characteristics, can vary.

Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

1. A mount comprising:
an input side attachment member;
a plurality of isolation pads positioned within the input side attachment member, wherein at least two of the pads have different performance characteristics; and
an output side attachment member wherein at least a portion of the output side attachment is positioned within the input side attachment member, wherein one or more of the pads are PV-bonded to at least one of the input side attachment member and the output side attachment member.

2. The mount of claim 1 wherein the PV-bonding occurs substantially simultaneously.

3. The mount of claim 1 wherein at least two of the pads are PV-bonded together

4. The mount of claim 3 wherein the pads are PV-bonded to at least one of the input side attachment member and the output side attachment member and together via an intermediate metal insert substantially simultaneously.

5. The mount of claim 1 wherein the input side attachment member includes a base plate and a U-shaped member fastened together.

6. The mount of claim 1 further comprising a rate plate PV-bonded to at least one of the pads.

7. The mount of claim 1 wherein the mount is selected from the group consisting of an engine mount, a disk drive mount, and a seismic mount.

8. A mount comprising:
an input side attachment member;
a plurality of isolation pads positioned within the input side attachment member, wherein at least two of the pads having different performance characteristics; and
an output side attachment member positioned within the input side attachment member, wherein one or more of the pads are PV-bonded to at least one of the input side attachment member and the output side attachment member.

9. The mount of claim 8 wherein at least two of the pads are PV-bonded together

10. The mount of claim 8 wherein the input side attachment member includes a base plate and a U-shaped member fastened together.

11. The mount of claim 8 further comprising a rate plate PV-bonded to at least one of the pads.

12. The mount of claim 8 wherein the mount is selected from the group consisting of an engine mount, a disk drive mount, and a seismic mount.

13. The mount of claim 8 wherein the pads are PV-bonded to at least one of the input side attachment member and the output side attachment member and together substantially simultaneously.

14. A strut mount comprising:
an output side attachment member attached to the strut mount with a strut body; and
A plurality of isolation pads positioned between the output side attachment member and the strut body wherein at least two of the pads comprise different performance characteristics, and wherein at least two of the pads are PV-bonded to the strut body.

15. The mount of claim 14 wherein the pads are PV-bonded to the output side attachment member substantially simultaneously.

16. The strut mount of claim 14 wherein the at least two of the isolation pads are PV-bonded to each other.

17. The mount of claim 14 wherein the pads are PV-bonded to the output side attachment member and together substantially simultaneously.

18. The strut mount of claim 14 wherein the strut mount is an automotive strut mount.

19. A method of manufacturing a mount, the method comprising:
Positioning a plurality of isolation pads adjacent a surface of the mount, wherein at least two of the pads have different performance characteristics, and PV-bonding a portion of at least one of the pads to the surface of the mount.

20. The method of claim 19 further comprising:
PV-bonding at least two of the pads together.

21. The method of claim 19 further comprising:
Selecting the plurality of isolation pads in response to performance characteristics;
Positioning the plurality of pads in response to the performance characteristics; and
PV-bonding the plurality of pads substantially simultaneously.
